(19) United States
(12) Patent Application Publication
(10) Pub. No.: US 2009/0300356 A1
(43) Pub. Date: Dec. 3, 2009

(54) REMOTE STORAGE ENCRYPTION SYSTEM

(76) Inventor: Jeffrey L. Crandell, Hermosa Beach, CA (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/472,068

(22) Filed: May 26, 2009

Related U.S. Application Data
(60) Provisional application No. 61/056,176, filed on May 27, 2008.

(51) Int. Cl. H04L 9/08; H04L 9/32

(52) U.S. Cl. 713/170; 380/279; 380/44

(57) ABSTRACT

An exemplary remote storage encryption system includes a data storage unit and a key server having a key management module configured to communicate with a client device. The key management module stores at least one key access map that maps at least one access credential to at least one encryption key to determine which encryption key to provide to the client device. An exemplary method includes mapping the at least one access credential to the at least one encryption key, receiving a request for the encryption key from a remote requestor, accepting the access credential with the request, validating the access credential against a previously stored version thereof, retrieving the encryption key associated with the access credential based on the mapping, and sending the key to the remote requester.

### CROSS-REFERENCE TO RELATED APPLICATIONS

This application claims the benefit of application Ser. No. 61/056,176 filed on May 27, 2008, the contents of which are incorporated herein in their entirety.

### TECHNICAL FIELD

The present disclosure relates to data encryption, and more particularly to the generation and management of encryption keys by a remote server.

### BACKGROUND

A data encryption system can be an effective technique for securing sensitive data. Data encryption may rely on complementary algorithms to scramble (encrypt) and descramble (decrypt) data. The algorithms may be seeded with an encryption key, which may vary the outcome of the encryption. Encrypted data may be difficult to decipher or decrypt without knowledge of the key used for encryption. Accordingly, safe management of the key may be an important aspect to any data encryption system.

A flawed key management technique may limit the effectiveness of the encryption system. For example, one key management technique may rely on human users to create and provide keys. Encryption systems that rely on user provided keys may be susceptible to insecure or low quality keys, forgotten keys, and key sharing. Low quality keys may allow encrypted data to be susceptible to deciphering analysis techniques. Forgotten keys may lead to data that is permanently encrypted, and effectively lost. Key sharing between users may allow an unauthorized user access to encrypted data. Moreover, providing users direct knowledge of encryption keys may limit the ability to use an encryption system for authorizing access to encrypted data.

### BRIEF DESCRIPTION OF THE DRAWINGS

Exemplary illustrations of the disclosure will now be described, by way of example, with reference to the accompanying drawings, wherein:

FIG. 1 is a system diagram of an exemplary remote storage encryption system;

FIG. 2a is an exemplary removable data storage unit attached to a client computer system;

FIG. 2b is an exemplary removable data storage unit incorporating a biometric reader;

FIG. 2c is an exemplary removable data storage unit with an exposed controller and storage medium;

FIG. 3 depicts exemplary key access maps;

FIG. 4 is a flowchart depicting exemplary steps and decisions related to acquiring a key via a key request; and

FIG. 5 is a flowchart depicting exemplary steps and decisions related to processing a key request.

### DETAILED DESCRIPTION

Exemplary illustrations of a remote storage encryption system are described below. In the interest of clarity, not all features of an actual implementation are described in this specification. It will of course be appreciated that in the development of any such actual illustration, numerous implementation-specific decisions must be made to achieve the developers' specific goals, such as compliance with system-related and business-related constraints that will vary from one implementation to another. Moreover, it will be appreciated that such a development effort might be complex and time-consuming, but would nevertheless be a routine undertaking for those of ordinary skill in the art having the benefit of this disclosure.

Referring now to the drawings wherein like numerals indicate like or corresponding parts throughout the several views, exemplary embodiments are illustrated.

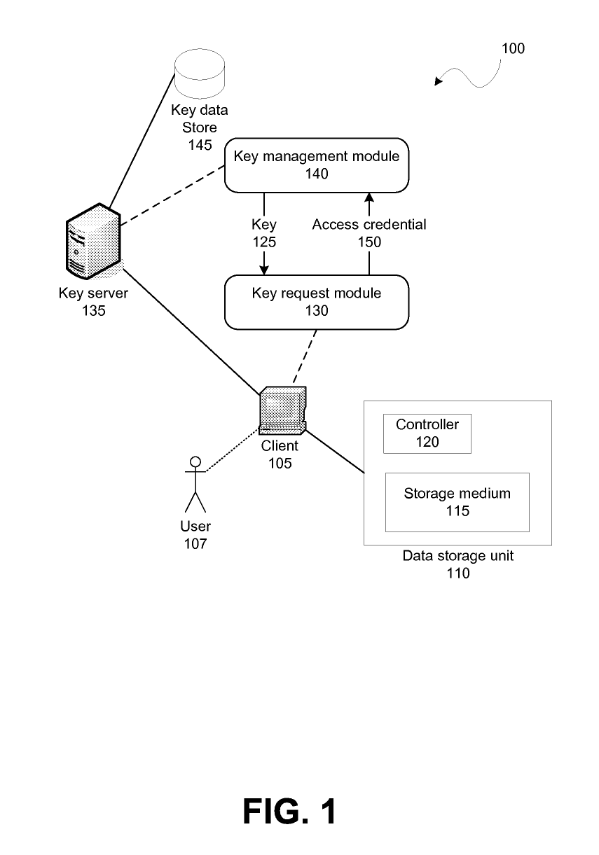

FIG. 1 illustrates an exemplary remote storage encryption system 100. The system 100 may include a client 105, which may be operated by a user 107, connected to a data storage unit 110. The data storage unit 110 may include a storage medium 115 accessible through a controller 120. The client 105 may include software for encrypting and decrypting data on the data storage unit 110. As discussed above, encryption software may rely on an encryption key 125 that must be provided at the time of encryption and decryption. The encryption software may include a key request module 130 for communicating with a key server 135 for acquisition of the encryption key 125. The key server 135 may include a key management module 140 and a key data store 145. The key management module 140 may generate, store, and selectively provide the encryption key 125 to the client 105 and key request module 130. The determination of whether to provide the key 125, as well as a determination of which of potentially numerous keys 125 to provide, may be based on an access credential 150 provided by the key request module 130.

The remote storage encryption system 100 may limit the ability of the user 107 to encrypt and decrypt data, e.g., data stored on the data storage unit 110. For example, the user 107 may be required to request a key 125 from the key server 135 prior to encrypting data. The key 125 that is provided by the key server 135 may be hidden or otherwise unavailable for inspection by the user 107. Because the key 125 is never directly available to the user 107, it would need to be requested from the key server 135 to decrypt the data. Accordingly, the remote storage encryption system 100 may further act as an authorization system by denying the key 125 to unauthorized users.

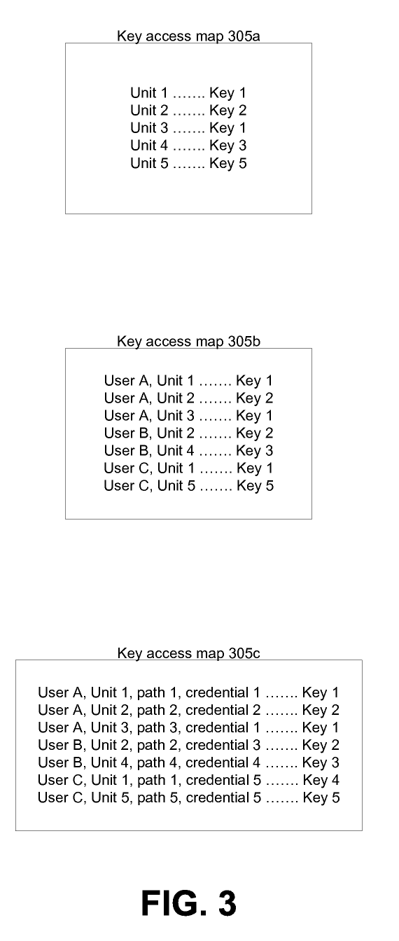

Access to the key 125 may require that the access credential 150 be provided to the key server 135. Moreover, the access credential 150 may be used to determine whether the key 125 should be provided to the client 105. Access credentials 150 will be discussed in more detail below with respect to FIG. 3. However, in general, the access credential 150 may be mapped to the key 125 according to a key access map 305a-c (FIG. 3). Thus, the access credential 150 may provide a basis for determining which key 125 to provide to the client 105.

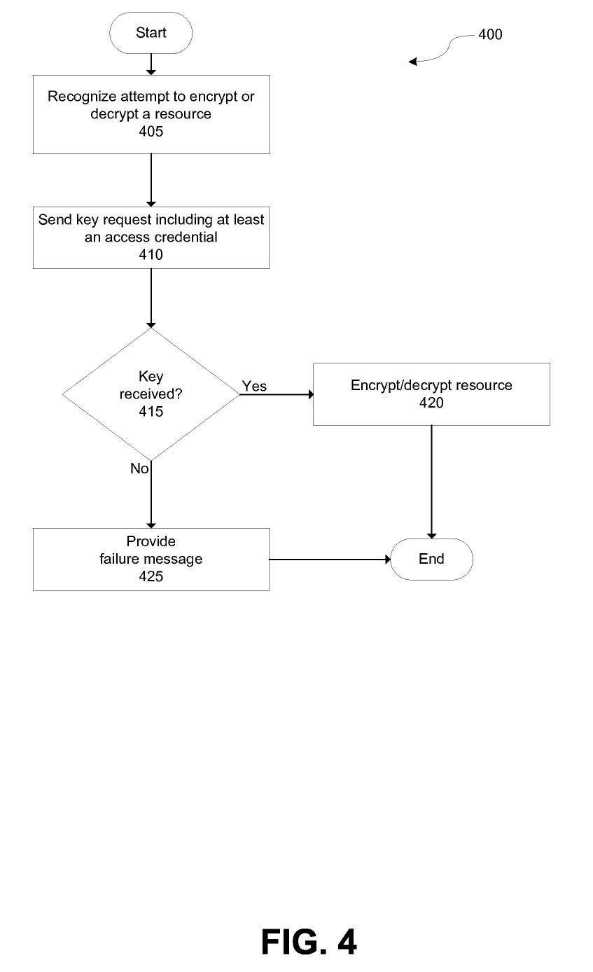

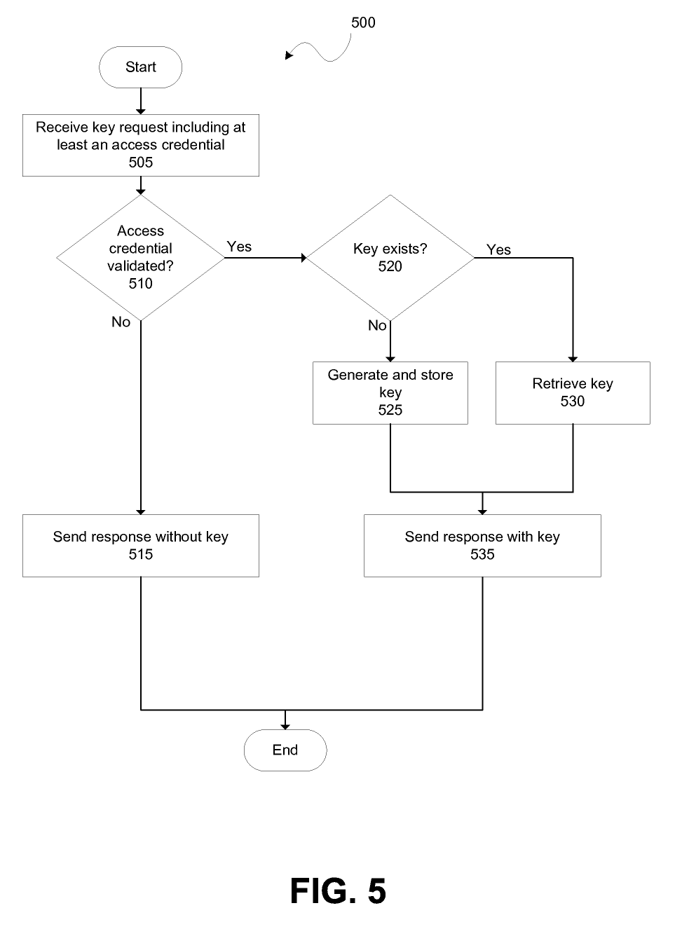

Details of exemplary processes are provided below with respect to FIGS. 4 and 5. However, a brief overview of the interactions between the components of the system 100 is provided to demonstrate an exemplary operation thereof. The user 107 of the client 105 may wish to encrypt data and store it on data storage unit 110. The user 107 may use the key request module 130 to request the encryption key 125 from the key server 135. The request may include an access credential 150. The access credential 150 may be used to authenticate the requester and to identify the data or data storage unit 110 being encrypted. The key management module 140 may receive the request and use the access credential 150 to determine which of potentially many managed keys to provide. If the key 125 does not exist, it may be generated. The client 105 may then use the provided key 125 to encrypt the data. A similar process may be used to retrieve the key 125 at the time of decryption.

The remote storage encryption system 100 may operate across at least one computer network. The line between the key server 135 and the client 105 represents generalized network connection. The network connection may be provided by a local area network (LAN), wide area network (WAN), as well the Internet. The actual connection may be made by various media including wires, radio frequency transmissions, and optical cables. Intervening networks and network devices, e.g. switches, routers, etc., that may be present in an implementation of the system 100 are omitted for simplicity of illustration.

The client 105 may be any general purpose computing device, such as a PC, or a specialized device. The client 105 may have software, such as an operating system with a network protocol stack, for establishing network connections to key server 135. The operating system may include other software for accessing the data storage unit 110. The operating system software for accessing the data storage unit 110 may be augmented with additional software, such as the key request module 130, configured to communicate with the key management module 140. The key request module 130 and the key management module 140 may communicate via a predefined communication protocol. For example, if the key server 135 is a web application server, the key request module 130 may implement the Hyper Text Transfer Protocol (HTTP) to communicate with key management module 140. While only one client 105 is illustrated in FIG. 1, multiple clients may be present in an actual implementation of the system 100. Moreover, the key server 135 and key management module 140 may manage a plurality of keys 125 for the clients 105. The key request module 130 may further include software for encrypting and decrypting data on the data storage unit using the key 125 obtained from the key request.

Data storage unit 110 may be any general purpose or specialty storage device such as a disk drive, an optical drive, a flash memory drive, etc. Data storage unit 110 may include a controller 120 and a storage medium 115. The connection between the data storage unit 110 and the client 105 may implement a data transmission bus. The client 105 may include a bus or host controller (not shown) that connects via the bus to the controller 120. The controller 120 may regulate the storage and retrieval of data to and from the storage medium 115. The storage medium 115 may be a magnetic disk, an optical disc, or a solid state device. A solid state storage medium 115 may include flash memory such as NAND based electrically erasable programmable read-only memory (EEPROM). The controller 120 may implement a bus protocol such as the universal serial bus (USB), and more particularly the USB mass storage device class. In another exemplary approach, the data storage unit 110 may be a remote device such as a file server or the like. Accordingly, the system 100 may allow for the encryption and decryption of files stored on or received from a remote data storage unit in addition to any locally connected data storage units 110.

In one exemplary approach, data storage unit 110 may include a customized controller 120 that is configured to provide part or all of the access credential 150. Additionally, the controller 120 may perform the encryption and decryption of the data using the key 125 received by the key request module 130. The data storage unit 110 may be integrated with client 105 or may be configured to be selectively attachable thereto. Similarly, the client 105 may be associated with multiple data storage units 110 at any given time. In generally, the data storage unit 110 may include an identifier, e.g., a serial number or the like, which may be a unique identifier. This identifier may be used as the access credential 150.

The key server 135 may be an application server such as a web application server. Application servers generally provide access to various facilities that combine programming logic, processing power, and data and file access. The key management module 140 may include software instructions that provide the encryption key 125 in response to a request from the key request module 130 including an access credential 150. In another exemplary approach, the request for a key 125 may be made directly to the key management module 140 through a web interface, or the like. The key 125 and key access map 305a-c (FIG. 3) may be stored in the key data store 145. The key server 135 may provide encryption keys 125 to the client 105 from a remote location. Accordingly, the key server 135 may be able to provide keys 125 to any networked client 105, including mobile clients and mobile data storage units 110, e.g., removable data storage units 110 that may be used with one or more different clients 105.

Web application servers may allow for access to computer program logic through an HTTP interface. Accordingly, web application servers typically provide an interface of procedures or functions, layered over top of HTTP, that may be called upon by remote computing devices, e.g. client 105. Accordingly, the client 105 may execute so-called remote procedure calls on the key server 135. Moreover, the remote device generally initiates the procedures on the key server 135 due to the nature of the underlying communication protocol. The key server 135 may communicate with the remote device, e.g. the client 105, in response to a specific request or remote procedure call. The functions and procedures that are remotely available may be included in the key management module 140. The key management module 140 may further include additional software or programming logic outside of any remote procedures that is necessary to provide the key 125 to the client 105. For example, the key management module 140 may include instructions for accessing and manipulating the key data store 145.

The key data store 145 may be a relational database management system (RDBMS), or the like. Many such systems, including SQL Server, Oracle, and MySQL, among others, are generally available. The key data store 145 generally stores data in row and column table format, and may include multiple tables. A row, or record, includes one or more columns, or fields, holding data values for specifically defined fields. Rows may be uniquely identified by the values of one or more columns. Indexes of one or more columns can be included to aide in searching for particular rows of the table.

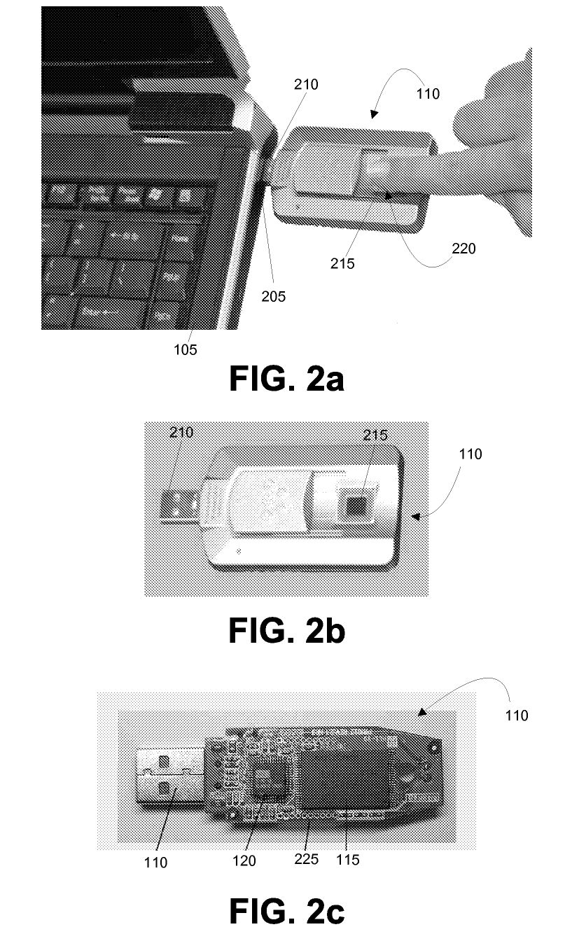

FIGS. 2a-c illustrate exemplary data storage units 110. The data storage unit 110 may be a removable USB device that connects to a USB port 205 on the client 105. Such a data storage unit 110 is commonly referred to as a USB flash drive indicating that it includes a USB connector 210 and provides the storage medium 115 as solid state flash memory. The controller 120 of a USB based data storage unit 110 may implement the USB mass storage device protocol. The controller 120 and storage medium 115 may be included on and interconnected by a printed circuit board 225.

A biometric reader may be used by client 105 for receiving biometric credentials from the user 107. The biometric credential may be used to authenticate the user 107 prior to requesting the encryption key 125. Further, the biometric credential, or a derivative thereof, may be used as the access credential 150. Accordingly, the biometric credential may be used by the key management module 140 to determine whether the key 125 should be provided to the client 105. The biometric reader 215 may be integrated with a flash memory data storage unit 110 that is removably attached to client 105. In another exemplary approach, the biometric reader may be a peripheral device (not shown) attached to client 105.

Biometric readers 215 may be available for determining different biometric credentials including fingerprints, palm prints, retina patterns, facial shapes, voice signatures, etc. The biometric reader 215 may store a previously recorded template of the particular biometric credential, e.g., a fingerprint 220. This template may be compared to a current biometric reading or scan. Some biometric readers 215 may convert the biometric reading into a derivative form, such as secured passkey, upon a successful match with the template. The derivative may then be used for authentication purposes in order to protect the actual template and the current scan data. For example, the derivative may be provided to the key management module 140 as the access credential 150. An exemplary method of producing a secure passkey derivative from a scan of a biometric credential may be found in PCT Patent Application PCT/US06/01900, the contents of which are incorporated herein in its entirety.

FIG. 3 illustrates exemplary key access maps 305a-c. Key access maps 305a-c may provide mappings of access credentials 150 to keys 125. Accordingly, the key management module 140 may use the key access maps 305a-c to determine which of potentially numerous keys 125 to provide to the client 105. For example, the key request module 130 may provide the access credential 150 with the key request. Upon receipt of the request, the key management module 140 may deliver the key 125 that maps to the provided access credential 150. The key 125 may be unique to the data storage unit 110, the client 105, and the user 107 or may be shared across any combination of data storage units, clients, and users. Moreover, particular files or sectors of the storage medium 115 of the data storage unit 110 may have distinct keys 125. For example, the same user 107 may have different keys 125 for different files on the same data storage unit 110. In one exemplary approach, the user 107 may be given the choice of keys 125 to use for a particular file or data storage unit 110. However, in another exemplary approach, the key management module 140 may provide a predetermined key 125 for a particular file or data storage unit 110.

The key access map 305a illustrates one exemplary approach, in which the access credential 150 may be limited to merely an identifier of the data storage unit 110. For example, the identifier may be a serial number, or the like, of the data storage unit 110. Because the key access map 305a does not include any information about the client 105 or user 107, the key 125 may be provided to any client or user that provides the data storage unit 110 identifier as the access credential 150. In such an approach, the key management module 140 may entirely disregard the identity of the user 107, if any, and merely provides the key 125 that maps to the provided identifier. For example, all requests that include a data storage unit 110 identifier (e.g., Unit 4) as the access credential 150 would receive the mapped key 125 (e.g., Key 3) regardless of the identity of the client 105 and user 107. Such an approach may be applicable to an environment where all users 107 and clients 105 have equal and full access to all data storage units 110. As depicted in the key access map 305a, keys 125 may be shared between multiple data storage units 110.

The key access map 305b illustrates another exemplary approach that may rely on an existing authenticated session of the operating system of the client 105 as the access credential 150. For example, the user 107 typically operates the client 105 under an authenticated session, which may be initiated by providing a user name and password at a login or session initiation prompt. The key request module 130 may provide an attribute for validating the existence of the session with the request for the key 125. For example, the key request module 130 may provide a user name or session identifier as the access credential 150. The access credential 150 may be augmented with an identifier of a particular data storage unit 110 in implementations involving multiple data storage units. Accordingly, the key management module 140 may manage one or more keys 125 for the user 107, including keys for one or more data storage units 110.

The key access map 305c illustrates another exemplary approach that may identify particular data segments of the data storage unit 110. Additionally, the key access map 305c may be configured to recognize different types of access credentials 150 for different users 107, data storage units 110, data segments, etc. Such an approach may provide flexibility in managing keys 125. For example, the user 107 may have different keys for different segments or files of the data storage unit 110. Further, keys 125 may require different types of access credentials 150. In addition to the types of access credentials 150 discussed above, other access credentials 150 may include passwords, digital certificates, biometric identifiers, etc. In another exemplary approach, the access credential 150 may be directed at a client 105 rather than the user 107 thereof. For example, the access credential may be provided by a digital certificate, or the like, that identifies the client 105.

While not depicted, key access map 305c may include additional data identifying the type of access credential 150 that must be provided with the key request. This additional data may be used by the key request module 130 to prompt the user 107 to provide the applicable access credential 150, e.g., entering a password, submitting to a biometric scan, etc. As discussed above, the key management module 140 may be able to accept a key request and access credential 150 directly without the key request module 130, e.g., through a web interface, or the like. In such an approach, the key request module 130 may be limited to interfacing with the data storage unit 110 to encrypt and decrypt data using the obtained key 125.

The key access maps 305a-c may be stored in key data store 145. For example, the key access maps 305a-c may be database tables with each mapping being a row thereof. The key data store 145 may hold additional tables and data (not shown) used to determine whether the key 125 should be provided to the client 105. In one exemplary approach, the key server 135 may also act as an authorization server. In such a capacity, the key data store 145 may include authorization data that may overrule the key access maps 305a. For example, even if the key request module 130 provides and access credential 150 that maps to a key 125, the key management module 140 may determine that the key 125 should not be provided to the client 105 based on the authorization data.

Computing devices such as key server 135, client 105, etc., may employ any of a number of computer operating systems known to those skilled in the art, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, notebook, laptop, or handheld computer, or some other computing device known to those skilled in the art.

Computing devices such as key server 135, client 105, etc., may each include instructions executable by one or more computing devices such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any tangible medium that participates in providing data (e.g., instructions) that may be read by a computer (e.g., by a processor of a computer, a microcontroller, etc.). Such a medium may take many forms, including, but not limited to, non-volatile media and volatile medial. Non-volatile media may include, for example, optical or magnetic disks, read-only memory (ROM), and other persistent memory. Volatile media may include, for example, dynamic random access memory (DRAM), which typically constitutes a main memory. A transmission media may facilitate the processing of instructions by carrying instructions from one component or device to another. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read

The key data store 145 may include a query processor that employs Structured Query Language (SQL) in addition to a language for creating, storing, editing, and executing stored procedures, such as the Procedural Language/Structured Query Language (PL/SQL) utilized by Oracle, as mentioned above. The key data store 145 may be a type of database other than an RDBMS such as a hierarchical database, a set of files, an application database in a proprietary format, etc. The key data store 145 generally includes a computing device employing a computer operating system such as one of those mentioned above, and may be accessed via a network in any one or more of a variety of manners, as is well known.

In the following exemplary process steps, the client 105, the user 107, and/or the data storage unit 110 may provide the access credential 150. Accordingly, the use of the term client 105 rather than user 107 should not be seen as limiting the exemplary step to only the client 105. Similarly, exemplary steps may indicate that the user 107 may be providing user input such as the access credential 150. However, the client 105 may be providing the input programmatically, e.g. through a data file or other information accessible to the client 105.

FIG. 4 illustrates a flowchart of exemplary process 400 for requesting an encryption key 125. The client 105 may include a computer-readable medium having stored instructions for carrying out certain operations described herein, including some or all of the operations described with respect to process 400. For example, some or all of such instructions may be included in the key request module 140. Process 400 is described as an interactive user processes. However, it is to be understood that automated or other types of programmatic techniques may implement the following steps.

The process 400 begins in step 405 when the key request module 130 may recognize an attempt to access data on the data storage unit 110. In one exemplary approach, the key request module 130 may include a background process that monitors the file system of the client 105. Upon detecting or recognizing the attempt to access the data storage unit 110, or a portion thereof, the key request module 130 may become activated to generate a key request. In another exemplary approach, the key request module 130 may include a file system browser for identifying the contents of the data storage unit 110. Moreover, the key request module 130 may provide the only point of access to data and files stored on the data storage unit 110. The key 125 may be needed for both encrypting and decrypting data on the data storage unit 110. Accordingly, the same steps may occur regardless of whether the applicable data is in an encrypted or decrypted state. In another exemplary approach that allows the key 125 to be directly requested from the key management module 140, step 405 may be omitted.

Next, in step 410, a key request including at least an access credential 150 may be provided to the key management module 140. As discussed above, the access credential 150 may map to a key 125. Accordingly, the access credential 150 may be used by the key management module 140 to determine which key 125 to provide in response to the request. The access credential 150 may simply identify the data storage unit 110, or may authenticate the client 105 or user 107. For example, a biometric access credential may authenticate the user 107 while a data storage unit identifier may identify a particular data storage unit 110. Depending on the implementation of the system 100 and the key access map 305a-c, the request may include additional attributes used to identify a particular key 125. For example, different keys may be used for different users 107, data storage units 110, and locations of stored data such as file paths, drive partitions, data segments, etc. Accordingly, any information needed to identify the appropriate key may be included in the request along with the access credential 150.

In another exemplary approach that allows different types of access credentials 150 to be used for different data, process 400 may include an additional step for determining the appropriate access credential 150 to provide with the request. For example, there may be an initial inquiry to the key management module 140 that includes an identification of the data to be encrypted or decrypted. The identification may be based on the location of the data, e.g., the file path, drive partition, data segment, etc. In response to the initial inquiry, the key management module 140 may indicate which type of access credential 150 should be provided with the key request. As discussed above, key access map 305c may include additional data specifying the access credential type for each mapping. Upon receiving the credential type, the key request module 130 may prompt the user 107 to provide the applicable access credential, e.g., entering a password, submitting to a biometric scan, etc.

Next, in step 415, the key 125 may be received. The key request module 130 may receive a response from the key management module 140 including a response code or other type of status indicator indicating whether the key was received. Accordingly, the response may be analyzed to determine whether it includes the key 125. In one exemplary approach, the response may include the key 125 or may include an explanation regarding why the key 125 is not being provided. The determination of whether the key 125 is provided with the response may be based on additional steps conducted by the key management module 140. For example, process 500 described below, may determine whether the key 125 is provided with the response.

If the key 125 is received in step 415, the process may proceed to step 420. In step 420, the key 120 may be used to encrypt or decrypt data on the data storage unit 110. The key request module 130 may include encryption software and interface with the data storage unit 110 to encrypt the applicable data using the received encryption key 125. As discussed above, the applicable data may be the entire storage medium 115 of the data storage unit 110 or may be a particular location thereof, e.g. a file, partition, segment, etc. In one exemplary approach, the encryption or decryption may occur immediately. However, in another exemplary approach, the key may be stored for a period of time and used as necessary throughout the period. For example, a key may be received for use during a session. The key may be used and reused throughout the session. Moreover, the entire amount of applicable data may not be encrypted or decrypted at one time. For example, individual files may be encrypted or decrypted as necessary during the session. Following the encryption or decryption, process 400 may end.

If the key 125 is not received in step 415, the process may proceed to step 425. In step 425, the user may be notified regarding the failure to receive the key 125. The key management module 140 may provide information in response to the request detailing the reasons that the request failed. For example, the notification may indicate that the access credential 150 was invalid, that the user was not authorized to receive the requested key 125, etc. The user 107 may be given the opportunity to reenter the access credential 150 with a new request, or process 400 may end.

FIG. 5 illustrates a flowchart of exemplary process 500 for handling a key request. The key server 135 may include a computer-readable medium having stored instructions for carrying out certain operations described herein, including some or all of the operations described with respect to process 500. For example, some or all of such instructions may be included in the key management module 140.

The process 500 begins in step 505 when a request for a key 125 is received. As discussed above with respect to step 410, the request may include at least an access credential 150. The request may include additional attributes such as an identifier of the data storage unit 110, an identifier of the user 107, a location of the data on the data storage unit 110, e.g., a file path, drive partition, data segment, etc.

Next, in step 510, the access credentials 150 may be validated. Key management module 140 typically maintains a predetermined version of the access credential. In one exemplary approach, the key management module 140 may maintain a listing of data storage unit identifiers that are used as access credentials 150. In another exemplary approach, a template of a biometric credential may be stored during an initial scan or enrollment procedure. Accordingly, the access credential 150 received in the request may be compared against the predetermined version of the access credential. If the comparison indicates that the access credential 150 corresponds to the predetermined version of the access credential, then the access credential may be validated.

If the access credential 150 is not validated, a response may be sent without the requested key 125 in step 515. The response may include a response code or other explanation indicating the reason for the failed request as discussed above with respect to step 425. Following step 515, process 500 may end.

If the access credential 150 is validated, it may be determined if a key 125 exits in step 520. For example, if data is not currently encrypted, the encryption key 125 may not yet exist. The key access map 305a-c may be consulted to determine whether the key exists 125. In one exemplary approach, the key access map 305a-c may provide a mapping to an empty key value, which indicates that the key does not exits. In another exemplary approach, there may be no applicable mapping for the access credential 150 and additional attributes, if any, provided with the request. Accordingly, the lack of a mapping may provide the indication that the key does not exits.

If the key does not exist, it may be generated in step 525. For example, the key management module 140 may include a key generation algorithm that produces a unique key 125. In another exemplary approach, the key may not be unique, e.g., it may be the same key shared by other users 107, data storage units 110, etc. The key data store 145 may include additional data indicating whether a new or existing key should be generated for the request. Once generated, the key 150 may be stored in the key data store 145 and mapped in the key access map 305a-c to the provided access credential 130. For example, the key 150 may be stored in association with the access credential 130 and additional attributes, if any, provided with the request.

If the key does exist, it may be retrieved in step 530. For example, the key 125 may be stored in the key data store 145 according to mapping provided by the key access map 305a-c. The access credential 130 and additional attributes, if any, provided with the request may be used to resolve the mapping to identify and retrieve the key from the key data store 145.

Following steps 525 and 530, a response to the key request may be sent along with the key 125. As discussed above, the response may include a response code, or the like, indicating that the response includes the requested key 125. Following step 535, process 500 may end.

Accordingly, an exemplary system 100 and methods 400, 500 of remote encryption key storage have been described. The exemplary system 100 and methods 400, 500 may allow for the access of encryption keys 125 from remotely networked locations. The system 100 may be particularly suited to managing encryption keys 125 on behalf of users 107. A key request module 130 may be used to request an encryption key 125 when data needs to be encrypted or decrypted. The request may include an access credential 150 to identify at least the data subject to the encryption/decryption. The access credential as well as additional attributes included with the request may further identify the user thereby allowing different keys to be provided for different combinations of users and data. Additionally, particular types of access credentials 150, e.g., biometric credentials, may be associated with particular data. Accordingly, the remote storage encryption system 100 provides a flexible approach to managing encryption keys 125.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A method, comprising:
mapping at least one access credential to at least one encryption key;
receiving a request for the encryption key from a remote requestor;
accepting the access credential with the request;
validating the access credential against a previously stored version thereof;
retrieving the encryption key associated with the access credential based on the mapping; and
sending the key to the remote requester.

2. A method as set forth in claim 1, further comprising generating the encryption key.

3. A method as set forth in claim 1, further comprising mapping at least one of a data storage unit identifier, a user identifier, a data storage location, and a previously stored version of the access credential to the encryption key.

4. A method as set forth in claim 3, further comprising obtaining at least one additional attribute from the request including at least one of a data storage unit identifier, a user identifier, a data storage location with the request, and wherein retrieving the encryption key is based on said at least one additional attribute.

5. A method as set forth in claim 4, augmenting the access credential with at least one of said additional attributes.

6. A method as set forth in claim 3, further comprising delivering the encryption key mapped to the provided access credential.

7. A method as set forth in claim 1, further comprising sharing at least one encryption key with at least one of a plurality of users and a plurality of data storage units.

8. A method as set forth in claim 1, further comprising providing the access credential with the key request.

9. A method as set forth in claim 1, further comprising initiating an authentication session.

10. A method as set forth in claim 1, wherein the access credential includes at least one of a password, a digital certificate, and a biometric identifier.

11. A method as set forth in claim 1, further comprising:
encrypting a resource with the encryption key; and
decrypting the resource with the encryption key.

12. A system comprising:
a data storage unit; and
a key server in communication with said data storage unit, said key server including a key management module configured to communicate with a client device;
wherein said key management module stores at least one key access map that maps at least one access credential to at least one encryption key to determine which of said at least one encryption keys to provide to the client device.

13. A system as set forth in claim 12, wherein said key management module is configured to provide the at least one access credential with a key request received from the client device.

14. A system as set forth in claim 12, wherein said key management module is configured to receive a key request from a key request module stored on the client device.

15. A system as set forth in claim 14, wherein said key management module is configured to provide the at least one encryption key to the key request module.

16. A system as set forth in claim 14, wherein said key management module is configured to receive at least one of a user name, a session identifier, a password, a digital certificate, and a biometric identifier as the access credential from the key request module.

17. A system as set forth in claim 12, wherein the at least one access credential includes an identifier of said data storage unit.

18. A system as set forth in claim 12, wherein said key access map includes additional data identifying the type of access credential.

19. A system as set forth in claim 12, wherein said data storage unit is configured to provide at least a portion of the at least one access credential to said key management module.

20. A system as set forth in claim 12, wherein said data storage unit is selectively attachable to the client device.

21. A system as set forth in claim 12, wherein said data storage unit includes a unique identifier.

22. A system as set forth in claim 21, wherein the unique identifier of said data storage unit may be the at least one access credential.

23. A system comprising:
a data storage unit having a unique identifier, said data storage unit being selectively attachable to a client device; and
a key server in communication with said data storage unit, said key server including a key management module configured to communicate with the client device, said key management module storing at least one key access map that maps at least one access credential to at least one encryption key to determine which of said at least one encryption keys to provide to the client device and said key management module being configured to provide the at least one access credential with a key request received from the client device,
wherein said data storage unit is configured to provide at least a portion of the at least one access credential to said key management module.
